(19) United States
(12) Patent Application Publication
(10) Pub. No.: US 2007/0040668 A1
(43) Pub. Date: Feb. 22, 2007

(54) Recovery system with a more reliable network

(76) Inventors: Sampath Krishna, Winchester, MA (US); James A. Justice, Waltham, MA (US); George Liu, Stoughton, MA (US)

Correspondence Address: Iandiorio & Teska, 260 Bear Hill Road, Waltham, MA, 02451-1018, US

(21) Appl. No.: 11/207,033

(22) Filed: Aug. 18, 2005

(51) Int. Cl. G08B 29/00

(52) U.S. Cl. 340/506

(57) ABSTRACT

A recovery system including a station and a plurality of remote transmitting units linked to the station. Each remote transmitting unit includes a transmitter, a receiver, and a controller configured to periodically send a message via the transmitter. The controller receives, via the receiver, that same message from at least one other remote transmitting unit. The controller then provides a notification to the station when the message has not been received in a predetermined time period.

### FIELD OF THE INVENTION

This invention relates primarily to stolen vehicle recovery systems, recovery systems for other objects of value, and network systems in general.

### BACKGROUND OF THE INVENTION

The applicant's successful and popular vehicle recovery system sold under the trademark LoJack® includes a small electronic vehicle locating unit (VLU) with a transponder hidden within a vehicle, a private network of communication towers each with a remote transmitting unit (RTU), one or more law enforcement vehicles equipped with a vehicle tracking unit (VTU), and a network center with a database of customers who have purchased a VLU. The network center interfaces with the National Criminal Information Center. The entries of that database comprise the VIN number of the customer's vehicle and an identification code assigned to the customer's VLU.

When a LoJack® product customer reports that her vehicle has been stolen, the VIN number of the vehicle is reported to a law enforcement center for entry into a database of stolen vehicles. The network center includes software that interfaces with the database of the law enforcement center to compare the VIN number of the stolen vehicle with the database of the network center which includes VIN numbers corresponding to VLU identification codes. When there is a match between a VIN number of a stolen vehicle and a VLU identification code, as would be the case when the stolen vehicle is equipped with a VLU, and when the center has acknowledged the vehicle has been stolen, the network center communicates with the RTUs of the various communication towers (currently there are 130 nationwide) and each tower transmits a message to activate the transponder of the particular VLU bearing the identification code.

The transponder of the VLU in the stolen vehicle is thus activated and begins transmitting the unique VLU identification code. The VTU of any law enforcement vehicles proximate the stolen vehicle receive this VLU transponder code and, based on signal strength and directional information, the appropriate law enforcement vehicle can take active steps to recover the stolen vehicle. See, for example, U.S. Pat. Nos. 4,177,466; 4,818,988; 4,908,609; 5,704,008; 5,917,423; 6,229,988; 6,522,698; and 6,665,613 all incorporated herein by this reference.

It is important that all RTUs in a particular network transmit the appropriate message to the VLU to activate the VLU transponder. Currently, it is not always known when a particular RTU has failed. If an RTU fails, and the stolen vehicle is within range of that RTU but no other RTUs in the network, the transponder of the VLU in the stolen vehicle may not be activated.

### SUMMARY OF THE INVENTION

It is therefore an object of this invention to provide a more reliable recovery system network.

It is a further object of this invention to provide such a network which detects when an RTU unit may have failed.

It is a further object of this invention to provide such a network which provides a notification when an RTU is suspected of having failed.

The subject invention results from the realization that if each RTU is programmed to receive the periodic transmissions of another RTU, when no transmission is received within a predetermined time period, the “buddy” RTU can provide a notification to a central station concerning the missed transmission so the possibly failed RTU, which did not transmit as expected, can be serviced.

The subject invention, however, in other embodiments, need not achieve all these objectives and the claims hereof should not be limited to structures or methods capable of achieving these objectives.

A recovery system in accordance with the subject invention features a station and a plurality of remote transmitting units linked to the station. Each remote transmitting unit includes a transmitter, a receiver, and a controller configured to periodically send a message via the transmitter, receive via the receiver a message from at least one other remote transmitting unit, and to provide a notification to the station when that message has not been received in a predetermined time period.

Typically, the message transmitted by the remote transmitting units includes an identifier which is provided by the controller to the station in the notification. In one embodiment, each remote transmitting unit is linked to the station via a telephone land line. The transmitter is typically a radio frequency transmitter and a typical periodic message includes a synchronization code to be received by a locating unit.

A remote transmitting unit in accordance with this invention includes a transmitter, a receiver, and a controller configured to periodically send a message via the transmitter. The controller also receives, via the receiver, that same message from at least one other remote transmitting unit. The controller sends a notification when that message has not been received in a predetermined time period.

A recovery system in accordance with this invention features a network of remote transmitting units configured to activate a locating unit and a station which communicates with the network. Each remote transmitting unit includes a transmitter for transmitting signals to the locating unit, a receiver for receiving transmissions from at least one other remote transmitting unit, and a controller configured to process a transmission received from the at least one other remote transmitting unit and to provide a notification to the station when the transmission from the other remote transmitting unit has not been received in a predetermined time period.

A recovery method in accordance with the subject invention features programming selected remote transmitting units in a recovery network to periodically send a message, grouping remote transmitting units so at least one remote transmitting unit is configured to receive the message from at least one other remote transmitting unit in the group, and providing a notification when a remote transmitting unit does not receive the message within a predefined time period.

The message typically includes an identifier of the remote transmitting unit which transmits the message and the notification includes that identifier. Notification can be provided to a station linked to the remote transmitting units. One such message is a synchronization code to be received by a locating unit.

### BRIEF DESCRIPTION OF THE DRAWINGS

Other objects, features and advantages will occur to those skilled in the art from the following description of a preferred embodiment and the accompanying drawings, in which:

FIG. 1 is a block diagram showing the primary subsystems associated with a recovery system in accordance with the subject invention;

FIG. 2 is a block diagram showing in more detail the components of a typical remote transmitting unit and the method by which the various remote transmitting units, in accordance with this invention, monitor each other; and

FIG. 3 is a flow chart showing the primary steps associated with the programming of a remote transmitting unit controller in accordance with the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

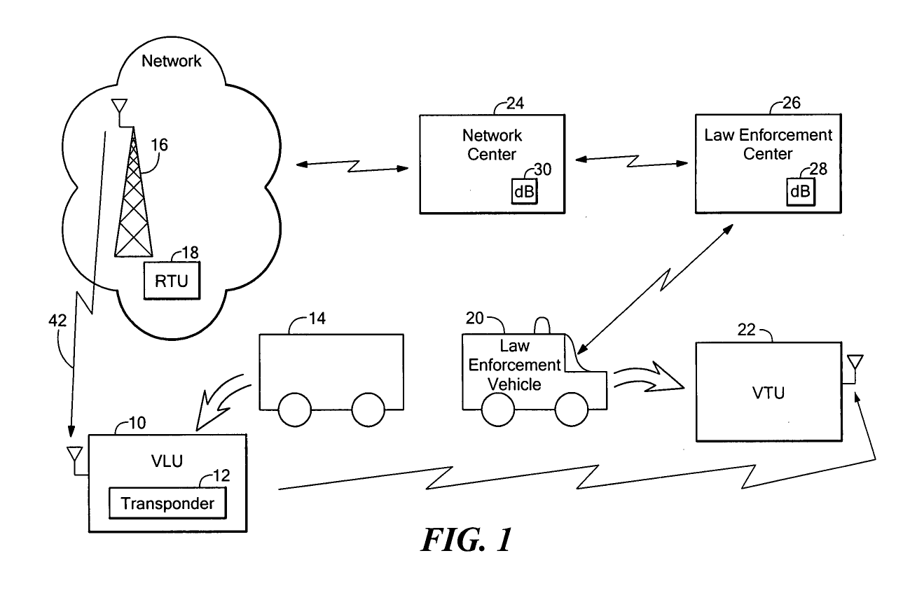

As discussed in the background section above, the applicant's successful and popular vehicle recovery system sold under the trademark LoJack® includes a small electronic vehicle locating unit (VLU) 10, FIG. 1 with a transponder 12 hidden within a vehicle 14, a private network of communication towers 16 each with a remote transmitting unit (RTU) 18, one or more law enforcement vehicles 20 equipped with a vehicle tracking unit (VTU) 22, and network center 24.

When a LoJack® product customer reports that her vehicle has been stolen, the VIN number of the vehicle is reported to law enforcement center 26 for entry into database 28 of stolen vehicles. Network center 24 includes software that interfaces with database 28 of law enforcement center 26 to compare the VIN number of the stolen vehicle with database 30 of network center 24 which includes VIN numbers corresponding to VLU identification codes. When there is a match between a VIN number of a stolen vehicle and a VLU identification code, as would be the case when stolen vehicle 14 is equipped with VLU 10, network center 24 communicates with the RTUs 18 of the various communication towers 16 and each tower transmits a message to activate transponder 12 of VLU 10 bearing the particular identification code.

Transponder 12 of VLU 10 in stolen vehicle 14, once activated, begins transmitting a unique VLU identification code. VTU 22 of law enforcement vehicle 20 proximate stolen vehicle 14 receives this VLU transponder code and, based on signal strength and directional information, the appropriate law enforcement vehicle can take active steps to recover stolen vehicle 14.

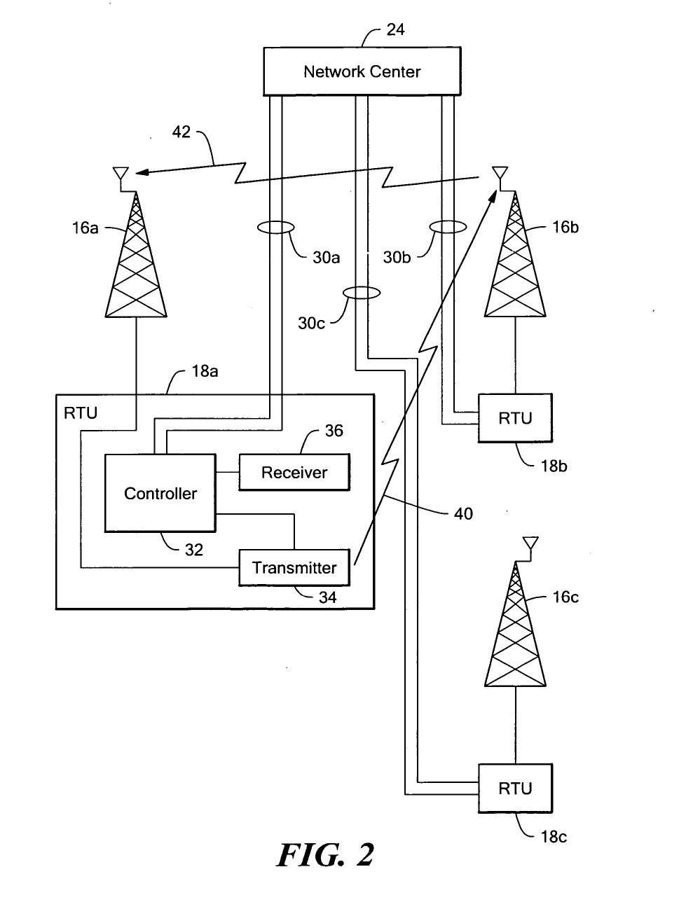

Typically, each RTU 18a-18c, FIG. 2 includes a controller 32, RF transmitter 34, and RF receiver 36 as shown for RTU 18a. Each RTU is linked to central station 24 via land lines 30a, 30b, and 30c respectively. There are typically two telephone lines for reliability. The center calls all the RTUs in a particular network and instructs them, for example, to transmit a message to a particular VLU in a stolen vehicle to activate the VLU transponder. The RTUs also receive other types of messages from the center and transmit different messages to the VLUs.

If RTU 18a and cell tower 16a, for example, are closest to the stolen vehicle but RTU 18a has failed, it will not transmit the message and the VLU transponder may not be activated especially if RTU/cell tower combinations 16b/18b and 16c/18c are out of range of the VLU.

In the subject invention, a failed condition of a RTU such as RTU 18a is detected as follows. Each RTU controller 32 is programmed to periodically send a message via transmitter 34 as shown at 40. In one example, the message is a synchronization message to be received by all VLUs in the vicinity. That message includes an identifier of RTU 18a. The receiver of RTU 18b also receives this message via cell tower antenna 16b. When the message is received by the receiver of RTU 18b, typically no action is taken by the controller of RTU 18b. When, however, the periodic message expected from RTU 18a is not received the receiver of RTU 18b, the controller of RTU 18b sends a notification to center 24 via land line 30b. In this way, because RTU 18a has not transmitted a message as expected, it may have failed and RTU 18b reports this condition to center 24. Service personnel can then be deployed to troubleshoot and/or correct any problems with RTU 18a.

Similarly, RTU 18b also periodically (e.g., every 16 minutes) sends, via an RF transmitter and antenna 16b, a message 42 to be received by a VLU and also received by receiver 36 of RTU 18a via antenna 16a. Provided that message is detected by controller 32 of RTU 18a, no notification is sent to center 24. When, however, message 42 from RTU 18b is not received by RTU 18a as expected within a given time frame (e.g., one hour), RTU 18a transmits, via telephone land lines 30a, a notification which is received at center 24. Based on that notification, personnel can be deployed to check the condition of RTU 18b. The notification from RTU 18a concerning the possibly failed condition of RTU 18b can also be sent wirelessly to service personnel, for example. The notification can include the RTU sender's identification, the identification of which RTU failed to transmit (RTU 18b), time and date information, and the like.

Thus, RTUs 18a and 18b are considered “buddies” each checking the operational status of the other. RTU 18c, in turn, can be similarly paired with another RTU (not shown) and so on until all the RTU/antenna combinations in a particular network are paired. Alternatively, RTU 18c can be programmed to listen for messages transmitted by RTU 16a and RTU 16b and to transmit a report if either RTU fails to transmit as expected. RTU 18c, in turn, can be monitored by RTU 18a, RTU 18b, or both. The grouping of RTUs within a given network can thus vary.

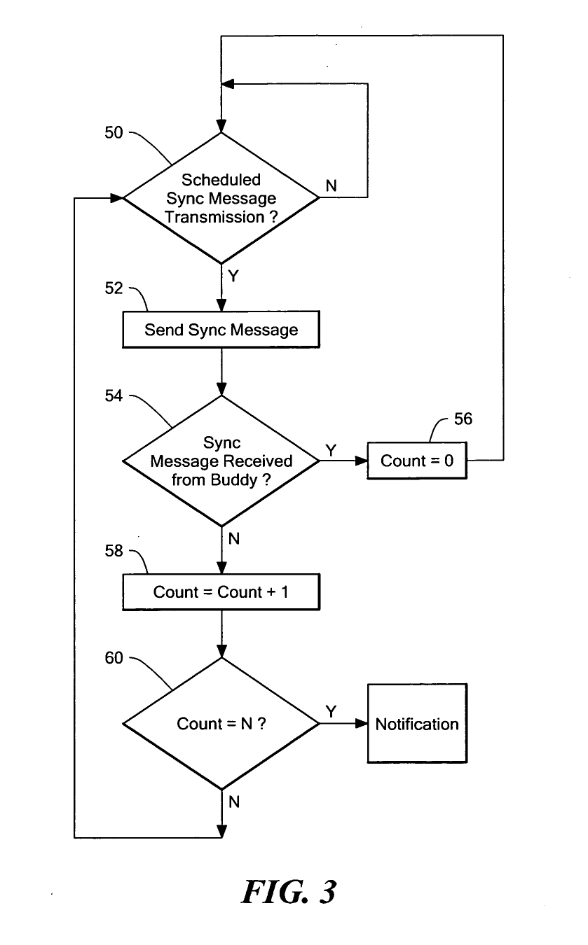

Thus, the controller of each RTU, which may be a computer, is programmed, in one example, to determine whether a synchronization message is now scheduled for transmission, step 50, FIG. 3. If so, the synchronization message is generated and transmitted for reception by all VLUs able to receive the transmission, step 52. Next, the controller determines whether a synchronization message has been received from an assigned “buddy” RTU, step 54. If so, the count is reset, step 56. If not, the count is incremented, step 58 and, whenever the count reaches some predetermined number N, step 60, a notification is sent by the RTU via its land line connection and/or wirelessly via its RF transmitter indicating a potential problem with the buddy RTU. In the example where each RTU transmits its synchronization message every 16 minutes, N can be set to 4 so an RTU is reported as failed if no synchronization message is received by the buddy RTU within an hour.

The result is a more reliable recovery system able to detect whether an RTU unit may have failed. Each RTU is programmed to receive the periodic transmissions of at least one other RTU and, when no transmission is received within a predetermined time period, the “buddy” RTU can provide a notification to a central station concerning the missed transmission so the possibly failed RTU, which did not transmit as expected, can be serviced.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A recovery system with a more reliable network, the system comprising:
a station; and
a plurality of remote transmitting units linked to the station, each remote transmitting unit including:
a transmitter,
a receiver, and
a controller configured to periodically send a message via the transmitter, receive via the receiver a message from at least one other remote transmitting unit, and to provide a notification to the station when that message has not been received in a predetermined time period.

2. The system of claim 1 in which the message includes a remote transmitting unit identifier provided by the controller to the station in the notification.

3. The system of claim 1 in which each remote transmitting unit is linked to the station via a telephone land line.

4. The system of claim 1 in which the transmitter is a radio frequency transmitter.

5. The system of claim 1 in which the message includes a synchronization code to be received by a locating unit.

6. A remote transmitting unit comprising:
a transmitter;
a receiver; and
a controller configured to periodically send a message via the transmitter, receive, via the receiver, said message from at least one other remote transmitting unit, and to send a notification when said message has not been received in a predetermined time period.

7. A recovery system comprising:
a network of remote transmitting units configured to activate a locating unit; and
a station which communicates with the network,
each remote transmitting unit including:
a transmitter for transmitting signals to the locating unit,
a receiver for receiving transmissions from at least one other remote transmitting unit, and
a controller configured to process a transmission received from the at least one other remote transmitting unit, and to provide a notification to the station when the transmission from the other remote transmitting unit has not been received in a predetermined time period.

8. A recovery method comprising:
programming selected remote transmitting units in a recovery network to periodically send a message;
grouping remote transmitting units so at least one remote transmitting unit is configured to receive the message from at least one other remote transmitting unit in the group; and
providing a notification when a remote transmitting unit does not receive the message within a predefined time period.

9. The method of claim 8 in which the message includes an identifier of the remote transmitting unit which transmits the message and the notification includes the identifier.

10. The method of claim 8 in which the notification is provided to a station linked to the remote transmitting units.

11. The method of claim 8 in which the message includes a synchronization code to be received by a locating unit.
